(19) United States
(12) Patent Application Publication
(10) Pub. No.: US 2024/0427297 A1
(43) Pub. Date: Dec. 26, 2024

(54) Apparatus and method for predicting the state of at least one system component of a cyclically producing installation

(71) Applicant: inpro Innovationsgesellschaft für fortgeschrittene Produktionssysteme in der Fahrzeugindustrie mbH, Berlin (DE)

(72) Inventors: Johannes Steenbuck, Berlin (DE); Fabian Hönl, Berlin (DE); Safa Evirgen, Herne (DE)

(21) Appl. No.: 18/684,719

(22) PCT Filed: Jul. 31, 2022
(86) PCT No.: PCT/DE2022/000086

§ 371 Date: Feb. 19, 2024

(30) Foreign Application Priority Data
Aug. 20, 2021 (DE) 10 2021 004 258.1

(51) Int. Cl. G05B 13/02

(52) U.S. Cl. CPC G05B 13/027

(57) ABSTRACT

An exemplary aspect of the present invention relates to an apparatus for predicting the state of at least one system component of a cyclically producing installation, comprising a recording unit for recording a time series of sensor data relating to the at least one system component of the cyclically producing installation and/or event data relating to the at least one system component, a calculation unit having at least one artificial neural network that is implemented therein and is intended to calculate a state prediction for the at least one system component on the basis of the time series of sensor data and/or event data, and an output unit for outputting the calculated state prediction for the at least one system component.

### FIELD

The present invention relates to an apparatus for predicting the state of at least one system component of a cyclically producing installation.

The present invention further relates to a method for predicting the state of at least one system component of a cyclically producing installation.

In addition, the present invention relates to a computer-readable medium.

### BACKGROUND

WO 2020/175460 A1 describes a control apparatus which uses a prediction model for a control variable of an installation in order to calculate a predicted value for the control variables from a measured value of the control variables. The control apparatus then outputs a command value for the control variable in order to reduce the probability of a future malfunction occurring.

However, it is not possible to predict the state of at least one system component of a cyclically producing installation using this known apparatus. The known apparatus merely continually optimizes a control variable.

JP 2019-126823 A also discloses a system for collecting states of a producing press. The system comprises a sensor plate, a plurality of pressure sensors, a data analyzer, and a data collection apparatus.

It would be advantageous to provide an apparatus and a method for predicting the state of at least one system component of a cyclically producing installation, for example a press for motor vehicle parts.

### SUMMARY OF THE INVENTION

According to a first aspect of the present invention, an apparatus is provided for predicting the state of at least one system component of a cyclically producing installation, comprising a capturing unit for capturing a time series of sensor data for the at least one system component of the cyclically producing installation, a calculation unit having at least one artificial neural network implemented therein for calculating a state prediction for the at least one system component on the basis of the time series of sensor data, and an output unit for outputting the calculated state prediction for the at least one system component.

Some advantageous embodiments of the first aspect of the present invention include at least one feature from the following list:
the artificial neural network is trained with reference sensor data and event data which describe a reference state of the at least one system component or an identical system component
the calculation unit is configured to calculate the state prediction on the basis of a classification process, such as random forest, support vector machines, and/or an artificial neural network.
the calculation unit is configured to calculate the state prediction on the basis of an anomaly detection algorithm, such as isolation forest
the capturing unit is configured to capture sensor data relating to an actual value
the capturing unit is configured to capture sensor data relating to a position and/or angle of the at least one system component within a production cycle
the capturing unit is configured to capture sensor data relating to at least one of the following parameters: press position, tool number, pressure ACTUAL and pressure TARGET
the calculation unit is configured to split the time series of sensor data into subsets or sub-sections
the calculation unit is configured to extract characteristic features of the subsets or sub-sections
the calculation unit is configured to calculate a state prediction for the at least one system component on the basis of a subset or sub-section of the time series of sensor data
the output unit is configured to output the state prediction calculated on the basis of the subset or the sub-section of the time series of sensor data
the output unit comprises an evaluation unit, which outputs at least one of the following on the basis of the calculated state prediction: normal behavior of the at least one system component, abnormal behavior of the at least one system component, classification of the installation state with indication of a defective system component or a defective part
a first layer of the artificial neural network implemented in the calculation unit forms an input layer, which incrementally receives the captured time series of sensor data from a buffer memory of the capturing unit via an interface
the calculation unit is configured to analyze and assess the captured time series of sensor data on the basis of predefined evaluation rules for determining measures which prevent a partial or complete system failure of the at least one system component
the output unit comprises a data interface for outputting the generated state prediction for the at least one system component to a monitoring center and/or a user interface
the apparatus comprises a memory for storing captured sensor data, reference sensor data, event data, and/or state predictions
the apparatus comprises a receiver for receiving sensor data
the capturing unit comprises the receiver for receiving sensor data
the apparatus comprises a transmitter for transmitting captured sensor data, reference sensor data, event data, and/or state predictions to a computer, to a mobile terminal device such as a smartphone or a tablet, to a server, or to a cloud-based server
the output unit comprises the transmitter for transmitting captured sensor data, reference sensor data, event data, and/or state predictions

According to a second aspect of the present invention, a method is provided for predicting the state of at least one system component of a cyclically producing installation, comprising capturing a time series of sensor data for the at least one system component of the cyclically producing installation, calculating a state prediction for the at least one system component by means of at least one artificial neural network on the basis of the time series of sensor data, and outputting the calculated state prediction for the at least one system component.

Some advantageous embodiments of the second aspect of the present invention include at least one feature from the following list:
before evaluating live data, a model is trained, wherein event data which describe a reference state of the at least one system component or an identical system component are associated with reference sensor data
the state prediction is calculated on the basis of a classification process, such as random forest, support vector machines, and/or an artificial neural network
the state prediction is calculated on the basis of an anomaly detection algorithm, such as isolation forest
sensor data are captured relating to an actual value
sensor data are captured relating to a position and/or angle of the at least one system component within a production cycle
sensor data relating to at least one of the following parameters are captured: press position, tool number, pressure ACTUAL and pressure TARGET
characteristic features of the subsets or sub-sections are extracted, for example characteristic features of the sub-sections of a stroke of the at least one system component
characteristic features include: maximum, minimum, and/or statistical moments.
the state prediction for the at least one system component is calculated on the basis of a subset or sub-section of the time series of sensor data.
the state prediction calculated on the basis of the subset or the sub-section of the time series of sensor data is output
at least one of the following is output on the basis of the calculated state prediction: normal behavior of the at least one system component, abnormal behavior of the at least one system component, classification of the installation state with indication of a defective system component or a defective part.
at least one of the following is output on the basis of the calculated state prediction: valve in order, valve not in order, nitrogen container defective, nitrogen container not defective, normal behavior of the at least one system component, abnormal behavior of the at least one system component.
the captured time series of sensor data is analyzed and assessed on the basis of predefined evaluation rules for determining measures which prevent a partial or complete system failure of the at least one system component
a system failure warning signal is generated once the trained model predicts a failure of the at least one system component
the generated system failure warning signal is output via an interface
the event data include idle state messages, start-up messages and stoppage messages, process steps, error messages, warnings, and/or maintenance measures for the at least one system component

According to a third aspect of the present invention, a non-volatile, computer-readable medium is provided in which a set of computer-readable commands is stored which, when executed by at least one processor, cause an apparatus to do the following: capture a time series of sensor data for the at least one system component of the cyclically producing installation, calculate a state prediction for the at least one system component by means of at least one artificial neural network on the basis of the time series of sensor data, and output the calculated state prediction for the at least one system component.

Some advantageous embodiments of the third aspect of the present invention include at least one feature from the list provided in conjunction with the second aspect.

Noticeable advantages can be achieved with embodiments of the present invention. An apparatus and a method for predicting the state of at least one system component of a cyclically producing installation are provided.

The overall equipment effectiveness (OEE) describes the effectiveness of the installation. One of the parameters which makes up this characteristic value is availability. By means of embodiments of the present invention, possible damage to at least one system component can be predicted in good time. Subsequently, defined message channels can be initiated and a defect can be investigated and remedied at a suitable point in time such that the producing installation is not stopped in an unscheduled manner. Therefore, the OEE increases when unscheduled stoppages are reduced.

Furthermore, there are savings in terms of resources such as storage capacity, energy, and outlay.

By means of certain embodiments of the present invention, the at least one system component can also be monitored in real time.

### BRIEF DESCRIPTION OF THE DRAWINGS

FIG. 1 is a schematic view of an exemplary producing installation,

FIG. 2 is a schematic chart of a training phase of an apparatus according to at least some embodiments of the present invention,

FIG. 3 is a schematic chart of a productive phase of an apparatus according to at least some embodiments of the present invention, and

FIG. 4 is a schematic view of an apparatus according to at least some embodiments of the present invention.

### EMBODIMENTS OF THE INVENTION

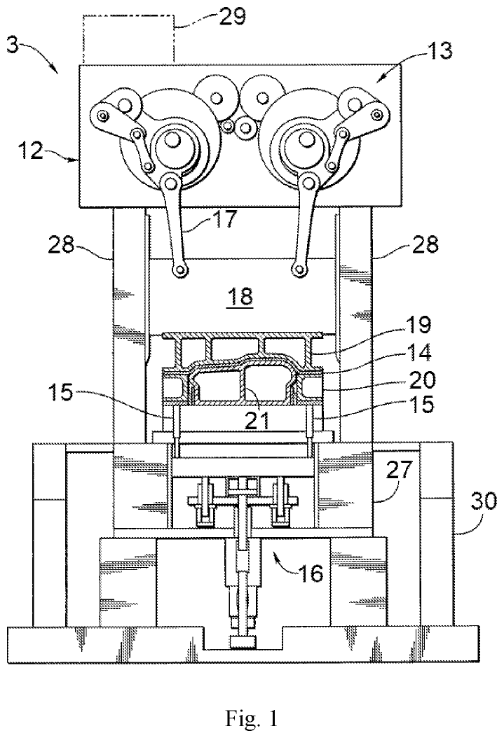

FIG. 1 is a schematic view of an exemplary producing installation 3. The producing installation 3 shown is a forming installation in the form of a single action press comprising an integral workpiece holder, which is supported on nitrogen gas springs. The forming installation comprises a head part 12 having two eight-link tappet drives 13, which each comprise a tappet connecting rod 17 coupled to a drawing tappet 18. The head part 12 is connected to a platen 27 by means of press uprights 28. The press further comprises a motor 29 for driving the tappet drives 13.

A die 19 or an upper platen is fastened to the drawing tappet 18. The forming installation further comprises a blank holder 20, on which a part 14 to be drawn or a workpiece in the form of a blank can be placed. The part 14 to be drawn can be pressed into the die 19 by means of a punch 21 in order to obtain a desired shape of the part 14 to be drawn. In other words, the die 19 and the punch 21 interact to form a workpiece 14 into a desired shape.

The blank holder 20 is supported by nitrogen gas springs 15 or pressure pins. In addition, the press comprises a hydraulic drawing cushion arrangement 16, which is supported by the press bed 30, which assists in the absorption of impact forces during operation of the press.

A process for forming a workpiece 14 can be split into different phases. Each forming process constitutes a forming cycle, and a plurality of forming cycles usually do not differ from one another in terms of their phases. This means that time series of sensor data from sensors that are coupled to different system components of the producing installation 3 usually do not differ in terms of the different phases of the forming cycles.

In the event of damage to a system component, it needs to be replaced or repaired. For an event of this kind, event data can be incorporated in a technical handbook, for example, such that a damage, error and/or maintenance history of the producing installation 3 is documented. Log files can also be generated, which include event data. Log files are generally files in which process data from an observation unit or one or more system components are stored. These event data can include, for example, damage, warning and error events, as well as maintenance measures relating to system components of the installation. Event data relating to maintenance measures can for example be the type of maintenance measure, the point in time of the maintenance measures, and/or the time interval between maintenance measures that are performed. In addition, for example for the installation 3 or the individual system components, idle state messages, start-up messages and stoppage messages, process steps, error messages, damage, warnings, and maintenance measures can be recorded and stored in the log files.

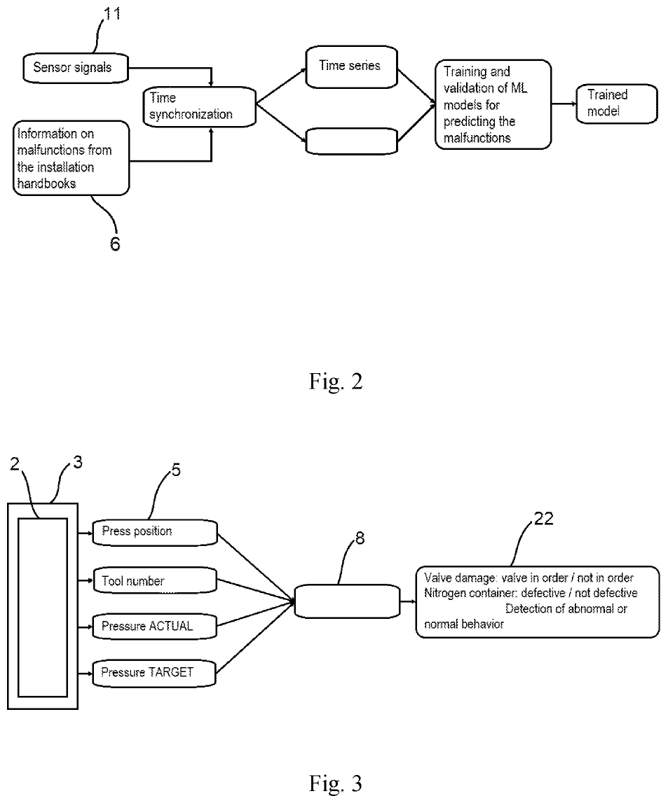

FIG. 2 is a schematic chart of a training phase of an apparatus according to at least some embodiments of the present invention. An apparatus of this kind for predicting the state of at least one system component of a cyclically producing installation is shown and described in conjunction with FIG. 4.

Before evaluating live data, which are captured by means of sensors coupled to at least one system component of the producing installation 3 during a plurality of production cycles, a model is trained. Here, event data 6 which describe a reference state of the at least one system component or an identical system component are associated with captured reference sensor data 11. Event data 6 can for example include idle state messages, start-up messages and stoppage messages, process steps, error messages, damage, warnings, and/or maintenance measures for the at least one system component.

In other words, reference sensor values 11 are first ascertained and collected. The ascertained reference sensor values 11 are usually stored locally or in a cloud environment. The ascertained reference sensor values 11 are then brought to a sufficiently high data quality such that time series can be reproduced which describe a production process independently of certain production parameters (such as the process time). In addition to the reference sensor values 11, technical documentation is consulted, in particular specifically that containing entries on servicing measures. In a special labeling process, the reference sensor data 11 are correlated with the information or event data 6 from the technical documentation such that event-oriented analyses can be performed in addition to time series analyses. The training and validation of machine learning models is required for predicting malfunctions or for the state prediction for the at least one system component by means of an apparatus according to the invention.

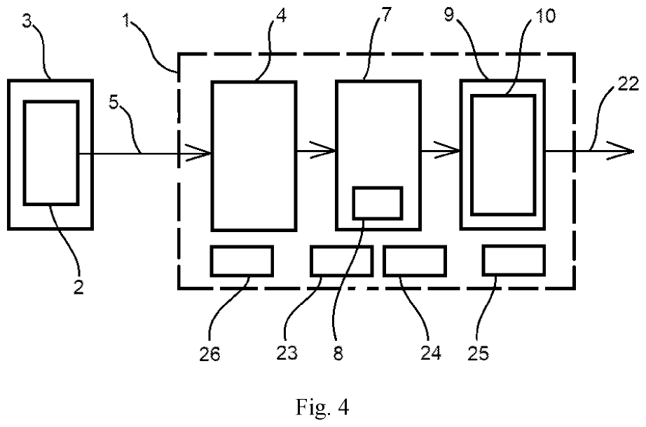

FIG. 3 is a schematic chart of a productive phase of an apparatus according to at least some embodiments of the present invention. An apparatus of this kind for predicting the state of at least one system component of a cyclically producing installation is shown and described in conjunction with FIG. 4.

When evaluating live data, a time series of sensor data 5 for the at least one system component 2 of the cyclically producing installation 3 is captured. For the example of the press shown in FIG. 1, sensor data 5 of this kind can contain an actual pressure of the hydraulic drawing cushion arrangement and/or a position of the press. Further values can for example be a tool number and/or a target pressure of the hydraulic drawing cushion arrangement. The sensor data are captured in an automated manner.

A state prediction for the at least one system component 2 is then calculated by means of at least one artificial neural network 8 on the basis of the captured time series of sensor data 5. First, the captured sensor data are standardized and features describing the process are extracted. The state prediction is calculated on the basis of at least one classification process. Examples of processes are random forest, an artificial neural network, and/or support vector machines. For the classification process, the time series of sensor data 5 can be split into subsets or sub-sections. In a case such as this, characteristic features of the subsets or sub-sections can also be extracted. Examples of characteristic features include a maximum, a minimum, and/or statistical moments. The state prediction for the at least one system component can thus also be calculated on the basis of a subset or sub-section of the time series of sensor data 5.

The standardization of the captured data aims to negate any changes to the process which do change the trend of the sensor data but do not change the state of the producing installation or the module in question. These include, for example, the change in the duration of a process cycle or the production of a different workpiece. Features of the resulting time series of a production cycle which describe the state can then be extracted. In this case, the data required are also considerably reduced, meaning that the required computing and memory capacity is significantly reduced.

After calculating the state prediction, the calculated state prediction for the at least one system component 2 is output. The calculated state prediction can also be output on the basis of the subset or the sub-section of the time series of sensor data. The output of the calculated state prediction usually contains at least one of the following: normal behavior of the at least one system component, abnormal behavior of the at least one system component, classification of the installation state with indication of a defective system component or a defective part. For the example of the press shown in FIG. 1, the calculated state prediction can be output as follows, for example: valve in order, valve not in order, nitrogen container defective, nitrogen container not defective, normal behavior of the at least one system component, abnormal behavior of the at least one system component.

The captured time series of sensor data 5 is usually analyzed and assessed on the basis of predefined evaluation rules for determining measures which prevent a partial or complete system failure of the at least one system component 2. For example, a system failure warning signal can be generated once a threshold value being exceeded results from the captured time series of sensor data, this being able to indicate future damage to the system component 2. The generated system failure warning signal is then output via an interface, e.g. to a system monitoring center and/or to a user of the production installation.

FIG. 4 is a schematic view of an apparatus 1 for predicting the state of at least one system component 2 of a cyclically producing installation 3 according to at least some embodiments of the present invention. The prediction apparatus 1 is coupled to a system component 2 of the installation 3 to be monitored by means of one or more data interfaces. The system component to be monitored can contain a plurality of external or integrated sensors, which provide sensor data 5.

The apparatus 1 can comprise a receiver 26. The receiver 26 can be configured to receive information in accordance with at least one cellular or non-cellular communication technology. The receiver 26 can comprise more than one receiver. The receiver 26 can be configured to operate in accordance with the standards of the Global System for Mobile Communications (GSM), Wideband Code Division Multiple Access (WCDMA), 5G, Long Term Evolution (LTE), IS-95, Wireless Local Area Network (WLAN), Ethernet, and/or Worldwide Interoperability for Microwave Access (WiMAX), for example. The receiver 26 is usually used when receiving sensor data 5 from the system component 2. Sensor data 5 can also be fed to the apparatus 1 by a user by means of a user interface. The user interface can comprise a computer keyboard, for example.

The apparatus 1 further comprises a processor 23, which can contain a single-core processor or multi-core processor, for example, with a single-core processor comprising one processing core and a multi-core processor comprising more than one processing core. The processor 23 can comprise more than one processor. The processor 23 can be a device for carrying out method steps in the apparatus 1. The processor 23 can be configured, at least in part by computer instructions, to perform actions.

The apparatus 1 can comprise a memory 24. The memory 24 can comprise a random access memory and/or a permanent memory. The memory 24 can comprise at least one RAM chip. The memory 24 can be accessible to the processor 23 at least in part. The memory 24 can be contained in the processor 23 at least in part. The memory 24 can be a device for storing information. The memory 24 can comprise computer instructions, the processor 23 being configured to execute these instructions. When computer instructions which are configured to cause the processor 23 to perform certain actions are stored in the memory 24 and the apparatus 1 as a whole is configured to be executed under the instruction of the processor 23 using computer instructions from the memory 24, the processor 23 and/or its at least one processing core can be considered to be configured to perform certain actions. The memory 24 can be outside the apparatus 1 at least in part, but can be accessible to the apparatus 1.

The apparatus 1 for predicting the state of at least one system component 2 of a cyclically producing installation 3 further comprises a capturing unit 4 for capturing a time series of sensor data 5 for the at least one system component 2 of the cyclically producing installation 3. A time series from one sensor or time series from a plurality of sensors can be captured by the capturing unit 4. Examples of sensor data 5 that are captured by the capturing unit are position sensor data and pressure sensor data. The captured sensor data 5 can be stored in the memory 24. In other words, the capturing unit 4 is configured to capture sensor data 5 relating to an actual parameter value and/or a position of the at least one system component 2 within a production cycle.

The apparatus 1 further comprises a calculation unit 7 having at least one artificial neural network 8 implemented therein for calculating a state prediction for the at least one system component 2 on the basis of the captured time series of sensor data 5. A first layer of the artificial neural network 8 implemented in the calculation unit 7 can form an input layer, which incrementally receives the captured time series of sensor data 5 from a buffer memory of the capturing unit 4 via an interface.

The calculation is performed by the at least one processing core of the processor 23. The artificial neural network 8 is trained with reference sensor data and event data which describe a reference state of the at least one system component 2 or an identical system component. The calculation unit 7 is configured to calculate the state prediction on the basis of a classification process, such as random forest, an artificial neural network, support vector machines, and/or artificial neural networks. The calculation unit 7 can be configured to split the time series of sensor data 5 into subsets or sub-sections. The calculation unit 7 can also be configured to extract characteristic features of the subsets or sub-sections. In a case such as this, the calculation unit 7 is usually configured to calculate a state prediction for the at least one system component 2 on the basis of a subset or sub-section of the time series of sensor data 5. The calculated state prediction can be stored in the memory 24.

The calculation of the state prediction by the calculation unit 7 is based on a model. Reference sensor data for at least one system component, for example pressure data from a press according to FIG. 1, are first recorded during operation, and the recorded reference sensor data are used to form the model of the drive to be monitored. Event data are additionally added to the model. Different types of damage or maintenance measures that are performed can be added to the model, for example. The frequency of damage or maintenance measures that are performed can also be added to the model, for example. This kind of labeling results in labeled time series of reference sensor data. The model can be stored in the memory 24 of the apparatus 1.

In the application of the apparatus 1 according to the invention, the captured sensor data 5 for the system component to be monitored are fed to the model and analyzed. The model formation is assisted by the users' domain knowledge. By the users continuing to exchange expert knowledge, the model can be continually optimized during the application.

The neural network 8 of the calculation unit 7 learns a pattern in the extracted features that describes a normal state and a pattern in the extracted features that describes a certain defect or an anomaly. The calculation unit 7 can also be configured to analyze and assess the captured time series of sensor data 5 on the basis of predefined evaluation rules for determining measures which prevent a partial or complete system failure of the at least one system component 2.

In addition, the apparatus 1 comprises an output unit 9 for outputting the calculated state prediction for the at least one system component 2. The output unit 9 can be configured to output a state prediction calculated on the basis of the subset or the sub-section of the time series of sensor data 5. The output unit 9 can comprise an evaluation unit 10, which outputs at least one of the following on the basis of the calculated state prediction: normal behavior of the at least one system component 2, abnormal behavior of the at least one system component 2, classification of the installation state with indication of a defective system component 2 or a defective part. In the case of the press shown in FIG. 1, the output 22 can include the following, for example: valve in order, valve not in order, nitrogen container defective, nitrogen container not defective, abnormal behavior of the at least one system component, normal behavior of the at least one system component.

The apparatus 1 can further comprise a transmitter 25. The transmitter 25 can be configured to transmit information in accordance with at least one cellular or non-cellular communication technology. The transmitter 25 can comprise more than one transmitter. The transmitter 25 can be configured to operate in accordance with the standards of the Global System for Mobile Communications (GSM), Wideband Code Division Multiple Access (WCDMA), 5G, Long Term Evolution (LTE), IS-95, Wireless Local Area Network (WLAN), Ethernet, and/or Worldwide Interoperability for Microwave Access (WiMAX), for example. The transmitter 25 is usually used when transmitting captured sensor data, event data, calculated future sensor data, and/or state predictions to a computer, to a mobile terminal device such as a smartphone or a tablet, to a server, to a cloud-based server, or to a network node. For example, a warning signal can be communicated to an employee's mobile terminal device or to a monitoring center of a producing industrial installation by means of the transmitter 25, such that a maintenance measure can be planned for and carried out on the at least one system component 2 in a timely manner.

As a result, the output unit 9 outputs a state prediction for the at least one system component. For example, a generated system failure warning signal is output via an interface.

Owing to the captured time series of sensor data, it is thus possible to capture, describe, and assess the current state of the system component 2. Furthermore, the prediction of a future state of the system component 2 is made possible. Servicing measures that are identified as being required can be planned and carried out in an optimal manner in terms of time, quality, and costs by means of the state prediction.

It goes without saying that the embodiments of the present invention are not limited to the specific structures or method steps that are disclosed herein, but can instead extend to their equivalents, as is apparent to a person of average skill in the relevant fields.

It also goes without saying that the terminology used here is used only to describe certain embodiments and should not be interpreted as limiting. The features, structures, or properties described can be combined in any suitable manner in one or more embodiments.

### INDUSTRIAL APPLICABILITY

Embodiments of the present invention are industrially applicable, for example in the prediction of the state of forming installations such as those in the motor vehicle sector.

### LIST OF REFERENCE SIGNS

1 Apparatus
2 System component
3 Producing installation
4 Capturing unit
5 Sensor data
6 Event data
7 Calculation unit
8 Artificial neural network
9 Output unit

10 Evaluation unit
11 Reference sensor data
12 Head part
13 Tappet drive
14 Part to be drawn or workpiece

15 Pressure pin
16 Hydraulic drawing device
17 Tappet connecting rod
18 Drawing tappet
19 Die
20 Blank holder
21 Punch
22 Output
23 Processor
24 Memory
25 Transmitter
26 Receiver
27 Platen
28 Press uprights
29 Motor
30 Press bed

1. An apparatus for predicting the state of at least one system component of a cyclically producing installation, comprising:
a capturing unit for capturing a time series of sensor data for the at least one system component of the cyclically producing installation,
a calculation unit having at least one artificial neural network implemented therein for calculating a state prediction for the at least one system component on the basis of the time series of sensor data, and
an output unit for outputting the calculated state prediction for the at least one system component.

2. The apparatus according to claim 1, wherein the artificial neural network is trained with reference sensor data and event data which describe a reference state of the at least one system component or an identical system component.

3. The apparatus according to claim 1, wherein the calculation unit is configured to calculate the state prediction on the basis of a classification process.

4. The apparatus according to claim 1, wherein the capturing unit is configured to capture sensor data relating to an actual value and/or a position of the at least one system component within a production cycle.

5. The apparatus according to claim 1, wherein the calculation unit is configured to split the time series of sensor data into subsets or sub-sections.

6. The apparatus according to claim 5, wherein the calculation unit is configured to extract characteristic features of the subsets or sub-sections.

7. The apparatus according to claim 5, wherein the calculation unit is configured to calculate a state prediction for the at least one system component on the basis of a subset or sub-section of the time series of sensor data.

8. The apparatus according to claim 7, wherein the output unit is configured to output the state prediction calculated on the basis of the subset or the sub-section of the time series of sensor data.

9. The apparatus according to claim 1, wherein the output unit comprises an evaluation unit, which outputs at least one of the following on the basis of the calculated state prediction: normal behavior of the at least one system component, abnormal behavior of the at least one system component, classification of the installation state with indication of a defective system componentor a defective part.

10. The apparatus according to claim 1, wherein a first layer of the artificial neural network implemented in the calculation unit forms an input layer, which incrementally receives the captured time series of sensor data from a buffer memory of the capturing unit via an interface.

11. The apparatus according to claim 1, wherein the calculation unit is configured to analyze and assess the captured time series of sensor data on the basis of predefined evaluation rules for determining measures which prevent a partial or complete system failure of the at least one system component.

12. The apparatus according to claim 1, wherein the output unit comprises a data interface for outputting the generated state prediction for the at least one system component to a monitoring center and/or a user interface.

13. A method for predicting the state of at least one system component of a cyclically producing installation, comprising:
capturing a time series of sensor data for the at least one system component of the cyclically producing installation,
calculating a state prediction for the at least one system component by means of at least one artificial neural network on the basis of the time series of sensor data, and
outputting the calculated state prediction for the at least one system component.

14. The method according to claim 13, wherein before evaluating live data, a model is trained, wherein event data which describe a reference state of the at least one system component or an identical system component are associated with reference sensor data.

15. The method according to claim 14, wherein the state prediction is calculated on the basis of a classification process.

16. The method according to claim 13, wherein sensor data relating to an actual value and/or a position of the at least one system component are captured within a production cycle.

17. The method according to claim 13, wherein the time series of sensor data is split into subsets or sub-sections.

18. The method according to claim 17, wherein characteristic features of the subsets or sub-sections are extracted.

19. The method according to claim 17, wherein the state prediction for the at least one system component is calculated on the basis of a subset or sub-section of the time series of sensor data.

20. The method according to claim 19, wherein the state prediction calculated on the basis of the subset or the sub-section of the time series of sensor data is output.

21. The method according to claim 13, wherein at least one of the following is output on the basis of the calculated state prediction: normal behavior of the at least one system component, abnormal behavior of the at least one system component, classification of the installation state with indication of a defective system component or a defective part.

22. The method according to claim 13, wherein the captured time series of sensor data is analyzed and assessed on the basis of predefined evaluation rules for determining measures which prevent a partial or complete system failure of the at least one system component.

23. The method according to claim 22, wherein a system failure warning signal is generated once a threshold value being exceeded results from the captured time series of sensor data.

24. The method according to claim 23, wherein the generated system failure warning signal is output via an interface.

25. The method according to claim 14, wherein the event data include idle state messages, start-up messages and stoppage messages, process steps, error messages, damage, warnings, position of the at least one system component within a production cycle, and/or maintenance measures for the at least one system component.

26. A non-transitory computer-readable medium in which a set of computer-readable commands is stored which, when executed by at least one processor, cause an apparatus to do the following:
capture a time series of sensor data for the at least one system component of the cyclically producing installation,
calculate a state prediction for the at least one system component by means of at least one artificial neural network on the basis of the time series of sensor data, and
output the calculated state prediction for the at least one system component.
